(19) United States
(12) Patent Application Publication
(10) Pub. No.: US 2005/0228102 A1
(43) Pub. Date: Oct. 13, 2005

(54) Nanocomposites based on polyolefin, method for the production thereof, and use of the same

(76) Inventors: Daniela Tomova, Bremen (DE); Stefan Reinemann, Rudolstadt (DE); Klaus Rucho, Mellenbach-Glasbach (DE); Angelo Schutz, Rudolstadt (DE)

Correspondence Address: Richard L Byrne;700 Koppers Building, 436 Seventh Avenue, Pittsburgh, PA, 15219-1818, US

(21) Appl. No.: 10/514,752

(22) PCT Filed: Apr. 9, 2003
(86) PCT No.: PCT/DE03/01158

§ 371 Date: Nov. 17, 2004

(30) Foreign Application Priority Data
May 18, 2002 (DE) 102 22 169.3

(51) Int. Cl. C08K 3/34

(52) U.S. Cl. 524/442; 524/445

(57) ABSTRACT

Nanocomposites based on HDPE-polyolefin having improved mechanical properties, especially an increased E module and an improved notch value. The nanocomposites contain at least two thermoplastic plastics: (A) a polyolefin, preferably between 70 and 99 wt. % of polyethylene, (B) a polyamide, preferably between 1 and 30 wt. % of polyamide 6, and between 1 and 10 wt. % of an organophyllically formed phyllosilicate. Optionally, a polyolefin grafted by maleic anhydride is added, forming between 1 and 10 wt. % of the total quantity. The nanocomposites can be used as injection moulded parts, containers or pipes.

The invention relates to nanocomposites based on polyolefin, in particular, on high-density polyethylene (HDPE) with an increased elasticity modulus and an improved notch value, and a method for the production thereof. The nanocomposites contain between 70 and 99 wt. % of HDPE, a polyamide, preferably between 1 to 30 wt. % of polyamide 6, and between 1 and 10 wt. % of phyllosilicate. Suitable phyllosilicates may include a natural sodium montmorillonite, hectorite, bentonite, or synthetic mica modified by onium ions.

### STATE OF THE ART

Inserting organophilic phyllosilicates in polymers by in-situ polymerization or through melt compounding has been described in the relevant literature and is known to an expert skilled in the art. It mostly results in an improvement of the mechanical and barrier properties, thermal stability, and flame resistance. A prerequisite for property improvement is the capability of the phyllosilicate layers to expand (intercalate) or to completely separate from each other (exfoliation). This creates an enlarged surface of the filler material and an enlarged boundary surface with the matrix polymer. To achieve intercalation or exfoliation when producing polymer nanocomposites, the phyllosilicates are modified by cation exchange with organic compounds and thus made organophilic. The organic compounds typically used are tetraalkyl ammonium ions that contain one or two C12 or C18 long chains. As the affinity to the matrix polymer is another prerequisite for property improvement, matrix polymers used are primarily polar ones such as polyamide, polyester, polyethylene oxide, polyvinyl alcohol, polyethylene imine and others that contain structural units compatible with the organophilic phyllosilicates. To improve compatibility with nonpolar polyolefins, the phyllosilicates are further modified using monomers, oligomers, silanes, or block copolymers [WO 0105879 A1, U.S. Pat. No. 5,910,523, WO 9907790 A1]. Additional modifications are prepared in dissolved state, require a great effort, and are costly.

An alternative way to bind phyllosilicates to nonpolar polymer matrices would be the use of bonding agents and intercalants directly during melt compounding. This is done in one or two stages starting at highly concentrated compositions followed by dilution. It is also known that suitable bonding agents are oligomers or polymers functionalized with carboxy or anhydride groups. These include polyolefins or copolymers grafted by maleic anhydride and based on olefin. Factors that are decisive for the selection of polyolefins grafted with maleic anhydride are maleic anhydride content, rheological properties, and compatibility with the matrix polymer. Block copolymers could also be used as bonding agents or intercalants. It was pointed out in this context that compatibility with the matrix polymer plays quite an important part here. Suitable block copolymers typically consist of polar blocks that facilitate coupling with the polar phyllosilicates, and of nonpolar blocks that are compatible with the nonpolar matrix polymer. The methods of inserting phyllosilicates into polyolefins listed above have been used successfully mainly with polypropylene and result in pronounced improvement of the mechanical stability of the composites. However, improvement of the mechanical properties of polyethylene nanocomposites, particularly HDPE nanocomposites using the bonding agents or intercalants mentioned above has not been achieved.

Just a flame-resistant effect has been described for polyethylene/clay nanocomposites in GB 1114174, GB 1118723, and WO 0166627 A1.

In-situ polymerization of HDPE in the presence of phyllosilicates modified by onium ions have been described in patents DE 198 46 314 and WO 9947598 A1. Exfoliation was shown but no improvement of mechanical properties, in particular, of the E modulus and notch value, were detected and achieved. The presence of active ions influences the effect of the catalysts and make chain growth more difficult as polymerization progresses. It is known that the property profile of linear polyethylenes such as HDPE largely depends on chain length or molar weight. Strength and resistance decline as molar weight drops. The mechanical properties of HDPE are also influenced by the formation of branches and by adding low-molecular olefin-containing compounds. This apparently does not produce any improvement when using the bonding agents and intercalants mentioned above in HDPE/phyllosilicate nanocomposites although there may be exfoliation.

### PROBLEM OF THE INVENTION

It is therefore the problem of the invention to improve the mechanical properties, in particular, the E modulus and notch value, of polyolefin nanocomposites, preferably of high-density polyethylenes (HDPE nanocomposites).

This problem is solved according to the invention by compounding the HDPE or, optionally, polypropylene, with a highly concentrated polyamide/phyllosilicate master batch and, optionally, with polyolefin grafted with maleic anhydride using an extrusion process.

According to the invention, the phyllosilicate is worked in polyamide into a highly concentrated master batch (20 to 40 wt. %) via melt compounding and, in a second stage, is intermixed with the HDPE in the melt. Polyolefin grafted with maleic anhydride may optionally be added during the second stage.

The method of the invention for producing HDPE nanocomposites with improved mechanical properties thus includes the stages below:

Melt intercalation of organophilic phyllosilicates in a polyamide matrix and preparation of a highly concentrated polyamide/phyllosilicate master batch containing between 20 and 40 wt.-% of organophilic phyllosilicate and between 80 and 60 wt.-% of polyamide 6 and

Compounding the master batch into the HDPE matrix and optional addition of a carboxylated polyolefin.

It is known that polyamides in general do not mix with polyolefins due to different polarities and structural differences. When mixing them using, for example, a single-screw extruder, without a conventional bonding agent, and with limited shear intensities, strong phase separation occurs in the HDPE/PA 6 blends. Bonding agents are used to improve compatibility. Suitable bonding agents are carboxylic acid or anhydride-modified polyolefins or copolymers. Despite such compatibilization, and even with increased shearing forces in a twin-screw extruder, no improvement in the mechanical properties of HDPE in the blend has been reported in the relevant literature. Mixing HDPE with small quantities of polyamide 6 using a twin-screw extruder may result in a laminar morphology. For example, toluene permeability is considerably reduced as compared to pure HDPE.

Surprisingly, the E modulus increases by approximately 28% and thermal stability by up to 30% only when using the HDPE nanocomposites of the invention with phyllosilicates intercalated in polyamide 6 (Table 1). This effect could be beneficial when producing fuel tanks or pipes from HDPE nanocomposites rather than from HDPE laminates with improved mechanical and barrier properties.

The invention is explained in greater detail by the examples below.

### EXAMPLES

A twin-screw extruder ZSK 25 with L/D=40 was used for producing the HDPE nanocomposites. According to the invention, highly concentrated polyamide 6/phyllosilicate compositions were first intermixed using a ZSK 25 twin-screw extruder at a ratio of 13:7 at temperatures in the range from 210 to 250° C. Montmorillonite modified by tetraalkyl ammonium ion was used as organophilic phyllosilicate. HDPE was compounded with the respective concentrate at temperatures in the range from 200 to 230° C. and a speed of 400 min⁻¹. The HDPE/PA 6 nanocomposites were injection-molded into test specimen for the mechanical and HDT tests and 1 mm plates for WAXS analysis using an Arburg Allrounder 320M 850-210 injection molding machine. The WAXS analyses revealed complete exfoliation of the phyllosilicates for all HDPE/PA 6 nanocomposites of the invention, which was confirmed using transmission electron microscopy (TEM). The results from the mechanical tests and HDT measurements performed on HDPE/PA 6 nanocomposites as explained in the examples below are shown in Table 1.

### Example 1

The polyamide 6/phyllosilicate concentrate was compounded with the HDPE matrix polymer with a melt-flow index of 11 ccm/10 min (HDPE-1) using a twin-screw extruder under the conditions described above into a nanocomposite containing 4.2 wt. % of organophilic phyllosilicate.

### Reference Example 1

HDPE with a melt-flow index of 11 ccm/10 min (HDPE-1) was compounded with 8.2 wt. % of polyamide 6 into blends under the same conditions as the HDPE nanocomposites.

### Example 2

The polyamide 6/phyllosilicate concentrate was compounded with the HDPE matrix polymer with a melt-flow index of 0.2 ccm/10 min (HDPE-1) using a twin-screw extruder under the conditions described above into nanocomposites containing 3.2 wt. % of phyllosilicate.

### Example 3

The polyamide 6/phyllosilicate concentrate and a HDPE grafted with maleic anhydride (HDPE-g-MA) were compounded with the HDPE matrix polymer with a melt-flow index of 0.2 ccm/10 min (HDPE-2) using a twin-screw extruder under the conditions described above into nanocomposites containing 3.2 wt. % of phyllosilicate.

TABLE 1

| | | | | E modulus | Tensile strength | Notch value | HOT, ASTM D648 |
|---|---|---|---|---|---|---|---|
| | Phyllosilicate | Polyamide 6 | HDPE-g-MA | DIN EN ISO 527 | DIN EN ISO 527 | Charpy, ISO 179 1eA | (1.8 MPa) |
| | [wt.-%] | [wt.-%] | [wt.-%] | [MPa] | [MPa] | [kJ/m²] | [° C.] |
| HDPE-1 | — | — | — | 1208 | 25.8 | 5.5 | 42 |
| Example 1 | 4.2 | 7.8 | — | 1520 | 27 | 3.5 | 50 |
| Reference | — | 8.2 | — | 1120 | 24.6 | 3.8 | 41 |
| example 1 | | | | | | | |
| HDPE-2 | — | — | — | 1180 | 27 | 38 | 41 |
| Example 2 | 3.2 | 6.1 | — | 1400 | 30 | 70 | 46 |
| Example 3 | 3.2 | 6.1 | 6 | 1413 | 30 | 43 | 42 |

1. A method for producing nanocomposites based on polyolefin wherein
a) 20 to 40 wt. % of organophilic phyllosilicate is worked with 80 to 60 wt. % of a polyamide matrix using melt intercalation (melt compounding) into a highly concentrated master batch, and
b) the highly concentrated master batch is subsequently compounded into a high-density polyethylene matrix (HDPE matrix).

2. The method according to claim 1 wherein the polyamide matrix is a polyamide 6 matrix.

3. The method according to claim 1 wherein the phyllosilicates are natural sodium montmorillonite, hectorite, bentonite, or synthetic mica modified with onium ions by cation exchange.

4. The method according to claims 1 through 3 wherein a carboxylated polyolefin representing 1 to 10 wt. % of the total quantity is added in step (b).

5. The method according to claim 4 wherein a polyolefin grafted with maleic anhydride, preferably a polyethylene grafted with maleic anhydride, is used as carboxylated polyolefin.

6. The method according to any one of claims 1 through 5 wherein the melt compoundierung in step (a) is performed at temperatures in the range from 210 to 250° C. and in step (b) at temperatures in the range from 200 to 230° C.

7. Nanocomposites based on polyolefin, produced according to claims 1 through 6, characterized in that they consist of at least two thermoplastic synthetic materials (A and B), wherein (A) is at least a polyolefin of 70 to 98 wt. % and (B) is at least a polyamide of 1 to 30 wt. %, and (C) is at least a phyllosilicate of 1 to 10 wt. % and (D) optionally is a carboxylated polyolefin of 1 to 10 wt. %.

8. The composition according to claim 7 wherein component A is a high-density polyethylene.

9. The composition according to claim 7 wherein component B is a polyamide 6.

10. The method according to claim 7 wherein component C is natural sodium montmorillonite, hectorite, bentonite, or synthetic mica modified with onium ions by cation exchange.

11. The method according to claim 7 wherein a polyolefin grafted with maleic anhydride, preferably a polyethylene grafted with maleic anhydride, is added as component D.

12. Use of the nanocomposites produced according to any one of claims 1 through 11 as injection-molded parts, pipes, containers.
